(19) United States
(12) Patent Application Publication
(10) Pub. No.: US 2023/0252225 A1
(43) Pub. Date: Aug. 10, 2023

(54) Automatic Text Summarisation Post-processing for Removal of Erroneous Sentences

(71) Applicant: Babylon Partners Limited, London (GB)

(72) Inventors: Vitalii ZHELEZNIAK, London (GB); Francesco MORAMARCO, London (GB)

(21) Appl. No.: 17/592,593

(22) Filed: Feb. 4, 2022

(51) Int. Cl. G06F 40/166; G06F 40/194; G06N 7/00; G06N 3/08

(52) U.S. Cl. CPC G06F 40/166; G06F 40/194; G06N 7/005; G06N 3/08

(57) ABSTRACT

The present application introduces improved methods for removing erroneous sections (e.g. hallucinated sentences) from computer-generated summaries. This improves the accuracy of the resultant summaries; but outputting corrected summaries for which the erroneous sentences have been removed. Importantly, the methods described herein do not require the training of any additional machine learning models, but instead work solely based on probabilities generated by the summary generation neural network that generates the summaries. Furthermore, the methodology described herein is able to work for any type of summary generation neural network.

### TECHNICAL FIELD

The present disclosure relates to methods and systems for removing erroneous statements from computer-generated summaries of text.

### BACKGROUND

This specification relates to neural network systems for producing summaries of text. The Internet and big data has meant that the amount of information available to information has increased greatly. Text summaries can be very useful by reducing the amount of information that needs to be reviewed whilst providing the most important points. Neural networks can be used to generate summaries of text automatically to avoid the need for reviewers to manually read information and compile summaries.

### SUMMARY

The present application introduces improved methods for removing erroneous sections (e.g. hallucinated sentences) from computer-generated summaries. This improves the accuracy of the resultant summaries, but outputting corrected summaries for which the erroneous sentences have been removed. Importantly, the methods described herein do not require the training of any additional machine learning models, but instead work solely based on probabilities generated by the summary generation neural network that generates the summaries. Furthermore, the methodology described herein is able to work for any type of summary generation neural network.

According to a first aspect there is provided a computer-implemented method for removing erroneous statements from computer-generated summaries of text. The method comprises: obtaining a document comprising a set of words and obtaining a summary of the document generated using a summary generation neural network configured to determine a probability of a given set of one or more words summarising an input document. The method further comprises dividing the summary into sub-summaries, each sub-summary including a corresponding subset of one or more words from the summary. The method further comprises, for each sub-summary: determining a set of one or more modified documents, wherein each modified document is determined by removing a corresponding selection of words from the document; for each modified document, determining, using the summary generation neural network, a difference between a probability that the sub-summary summarises the document and a probability that sub-summary summarises the modified document; determining whether the sub-summary is erroneous based on the one or more differences; and in response to determining that the sub-summary is not erroneous, adding the sub-summary to a corrected summary for output.

Arrangements are able to determine whether certain sections (e.g. sub-summaries) of a summary document are erroneous by determining whether there are any sections of the original document that cause a significant difference in the output of the summary document if they are removed from the document. Accordingly, one or more modified documents can be determined that include different subsets of words from the documents. If there is no significant variation in the probabilities output by the neural network for these one or more modified documents, relative to the probability output for the original document, then the sub-summary is likely to be erroneous, as it is largely independent of the input data.

The set of one or more modified documents may be the same for each sub-summary. Alternatively, a different set of one or more modified documents may be determined for each sub-summary. The probability differences may be measured in log probabilities (e.g. may be a difference between log probabilities or logarithm of a ratio of probabilities).

Determining one or more modified documents may comprise determining a plurality of modified documents, each comprising a different selection of words selected from the document.

Determining whether the sub-summary is erroneous based on the one or more differences may comprise: determining a measure of variability across the differences for the modified documents; and in response to the measure of variability for the sub-summary being greater than a predefined threshold, determining that the sub-summary is not erroneous and adding the sub-summary to the corrected summary for output.

Determining the measure of variability across the differences can comprise: determining a standard deviation over the differences; or determining a number of outliers within the differences. The measure of variability may be a measure of the number of outliers within the differences.

The method may further comprise: in response to the measure of variability for the sub-summary not being greater than the predefined threshold, determining that the sub-summary is erroneous. Where the sub-summary is determined to be erroneous, it may be filtered out of the summary document (e.g. by exclusion from a corrected summary document). Erroneous sub-summaries may also be output (e.g. for use in training a machine learning model, e.g. to identify erroneous sub-summaries or to improve the summary generation neural network).

Each modified document may comprise every word from the document with the exclusion of a corresponding excluded set of one or more words, wherein the excluded set of one or more words differs for each modified document. Each modified document may be generated by excluding a different set of one or more words from the modified document.

Each excluded set may comprises a different: selection of a predetermined number of words from the document; selection of a predetermined number of sentences from the document; selection of a predetermined number of statements from the document; or selection of a predetermined number of phrases from the document.

A different set of one or more modified documents may be determined for each sub-summary and utilised to determine the one or more differences for the corresponding sub-summary. Determining the corresponding set of one or more modified documents for a given sub-summary may comprise: determining an influence score for each subset of words in the document, the influence score representing the influence of the subset of words in the document on the probability of the sub-summary according to the summary generation neural network; determining a selection of subsets of words from the document that have the greatest influence on the sub-summary based on the influence scores; and determining the set of one or more modified documents for the sub-summary, wherein each modified document is formed through the removal of at least one of the selection of subsets of words from the document.

Each modified document may be formed by removing a different subset of words from the document, wherein each of the different subsets of words is selected from a selection of the most influential subsets of words, according to their corresponding influence scores. The selection of the most influential subsets of words may be a set of a predefined number of the most influential subsets of words or a set of subsets of words having an influence score that is greater than a given threshold.

The same set of one or more modified documents may be used for each sub-summary.

Each of the differences may be normalized to account for a size of the respective sub-summary. Each difference may be normalized to account for variations in the size (the number of words) in the sub-summaries.

Determining one or more modified documents may comprise determining only one modified document. In this case, the sub-summary may be determined not to be erroneous in response to the difference being greater than a predefined threshold. Determining only one modified document may comprise removing all words from the document (e.g. the modified document may be empty).

Determining, using the summary generation neural network, the difference between the probability that the sub-summary summarises the document and the probability that the sub-summary summarises the modified document may comprise: inputting the document into the summary generation neural network to determine a first value representing the probability that the sub-summary summarises the document; inputting the modified document into the summary generation neural network to determine a second value representing the probability that the sub-summary summarises the modified document; and determining a difference between the first and second values.

Each sub-summary may comprise a different: selection of a predetermined number of words from the summary; selection of a predetermined number of sentences from the summary; selection of a predetermined number of statements from the summary; or selection of a predetermined number of phrases from the summary.

The method may further comprise outputting the corrected summary. The corrected summary may be output in batches (e.g. outputting each non-erroneous sub-summary separately) or in one package as a completed corrected summary (e.g. after each sub-summary has been analysed). Output can be to memory, to a display and/or through communication to an external device.

According to a further aspect there is provided a system for determining summaries of text over multiple batches of text. The system comprises one or more processors configured to: obtain a document comprising a set of words; obtain a summary of the document generated using a summary generation neural network configured to determine a probability of a given set of one or more words summarising an input document; and divide the summary into sub-summaries, each sub-summary including a corresponding subset of one or more words from the summary. The one or more processors are further configured to, for each sub-summary: determine a set of one or more modified documents, wherein each modified document is determined by removing a corresponding selection of words from the document; for each modified document, determine, using the summary generation neural network, a difference between a probability that the sub-summary summarises the document and a probability that sub-summary summarises the modified document; determine whether the sub-summary is erroneous based on the one or more differences; and in response to determining that the sub-summary is not erroneous, add the sub-summary to a corrected summary for output.

According to a further aspect there is provided a non-transitory computer readable medium comprising computer executable instructions that, when executed by one or more processors, cause the one or more processors to perform a method comprising: obtaining a document comprising a set of words; obtaining a summary of the document generated using a summary generation neural network configured to determine a probability of a given set of one or more words summarising an input document; and dividing the summary into sub-summaries, each sub-summary including a corresponding subset of one or more words from the summary. The method further comprises, for each sub-summary: determining a set of one or more modified documents, wherein each modified document is determined by removing a corresponding selection of words from the document; for each modified document, determining, using the summary generation neural network, a difference between a probability that the sub-summary summarises the document and a probability that sub-summary summarises the modified document; determining whether the sub-summary is erroneous based on the one or more differences; and in response to determining that the sub-summary is not erroneous, adding the sub-summary to a corrected summary for output.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a Nock diagram of a communication system including automatic transcription summarisation;

FIG. 2 shows an encoder-decoder structure for summarisation;

FIG. 3 shows a method for removing erroneous statements from a computer-generated summary of text according to an embodiment;

FIG. 4 shows a method of determining a set of modified documents T according to an embodiment;

FIG. 5 shows a further method for removing erroneous statements from a computer-generated summary of text according to a further embodiment; and

FIG. 6 shows a computing device using which the embodiments described herein may be implemented.

### DETAILED DESCRIPTION

It is an object of the present disclosure to improve on the prior art, In particular, the present disclosure provides a system and method for removing erroneous text from a summary of a document.

A major weakness of contemporary summarisation models is the generation of summaries with “hallucinated” sentences, i.e. sentences that are not supported by the original text. Such hallucinations, can be divided into extrinsic and intrinsic hallucinations. Extrinsic hallucinations are sentences that have nothing to do with the original text. Intrinsic hallucinations are somewhat related to the original text but are still factually incorrect statements. The methodology described herein focusses on the problem of detecting and removing extrinsic hallucinations from summaries of text.

Some methods of hallucination identification rely on pre-trained classifiers that are configured to identify hallucinations (e.g. based on whether a given summary sentence disagrees with other statements in the summary or in the original document). These methods suffer from the drawback that the classifier neural network needs to be specifically trained to identify hallucinations using training data. The collation of this training data can be expensive and labour intensive. Furthermore, specifically trained classifier models may not be generally applicable to different contexts (e.g. to different documents that have different types of content). The methodology described herein avoids these issues by identifying hallucinations using only the outputs of the summary neural network itself. Accordingly, this methodology is more general and can be applied to any summarisation model to filter out hallucinations and/or erroneous text.

A summarisation model is a conditional probability model of the form P(S=s₁, . . . , sₖ|T=t₁, . . . , tₗ), where s₁, . . . , sₖ and t₁, . . . , tₗ are ‘atomic’ tokens or units (e.g. characters, subwords, words, etc.) in the summary and input document respectively. A summary unit Sᵢ (or sub-summary) comprises a set of summary tokens sᵢ. For instance, a summary unit Sᵢ may be a sentence, a phrase, a paragraph, a sub-phrase, or any other set of tokens. A summary unit Sᵢ is a subset of an overall summary document S generated for a given document T. A summary unit may be called a sub-summary. Similarly, a document unit Tᵢ is a subset of the document T being summarised.

A summarisation neural network may be utilised to determine the above conditional probability P(S=s₁, . . . , sₖ|T=t₁, . . . , tₗ) and may be trained based on a set of predetermined target summaries (e.g. by modifying the parameters of the summarisation neural network to reduce the error relative to the target summaries).

As the summarisation neural network models the probability that a given summary S=s₁, . . . , sₖ represents a summary of the input text T=t₁, . . . , tₗ (where l>k), the summarisation model can generate a summary by selecting words for the summary that have the highest probability.

According to the present methodology, a summary unit Sᵢ is a hallucination if it does not follow from any subset of the input text units Tᵢ. In other words, the summary model may have a tendency to generate this unit somewhat independently of the content of the particular document being considered.

Based on the above, a certain unit or subset of units may be a hallucination (may not follow from the input document) if the difference

P(Sᵢ|T)−P(Sᵢ|T′∈2^{T})

is small for all ‘reasonable’ subsets T′ of T. In the above, P(Sᵢ|T′) is the probability of unit Sᵢ given a subset T′={t₁, . . . , tₗ\tⱼ_{ₘ}, . . . , tⱼ_{ₙ}} of the document with the excluded subset {tⱼ_{ₘ}, . . . , tⱼ_{ₙ}} removed (the set difference of the document and the excluded subset).

As an illustrative example, if sentences (or another grouping of words) are removed one by one from the document and the probability of the summary unit Sᵢ does not change for any of these modified documents, then the summary unit Sᵢ is likely to be a hallucination. There is a caveat here, in that many different sentences, potentially far apart in the document, can imply the summary unit Sᵢ, so dropping just one such document sentence does not automatically guarantee a reduction in probability. Accordingly, the next section presents a general framework and discusses a few special cases.

Embodiments described herein make use of three functions. The first function, subsets(S,T)→C, generates a set C of contrastive subsets T′ based on the document T and potentially also the summary S or summary unit Sᵢ. Some simple examples are the leave-all-out function subsets(T)=∅ (i.e. remove the entire document to produce an empty set) and leave-one-out subsets(T)={T\Tᵢ|∀i} (i.e. remove units, Tᵢ, one by one).

In the above simple examples, the subsets function depends only on the document T, but more advanced options can also consider the summary S, e.g. remove the units to which the loss of the summary Sᵢ is most sensitive. This allows the modified documents to be focussed on only the most relevant sections of the document.

For instance, a summary-dependent subsets function subsets(S,T) can be dependent on an attribution function attr(Sᵢ,j) which takes a summary unit Sᵢ and index j and gives a real-valued attribution score for the unit Tⱼ in the transcript. In other words, this function can compute an attribution or “influence” score for each transcript unit Tᵢ on the generated summary unit Sᵢ.

More specifically, the attribution function attr(Sᵢ,j) may be based on a gradient with respect to hidden states of a loss function of the summary neural network for the transcript unit Tᵢ. The loss function may be the negative log likelihood of the summary unit Sᵢ according to the summary neural network conditioned on the given transcript unit Tᵢ.

Using this function, the system can select the most influential units to remove from the transcript. For instance, the top K transcript units Tⱼ can be removed, where K is a natural number. Alternatively, all Tⱼ units with attr(Sᵢ,j)>τ can be dropped, where τ is an influence threshold. Based on this, the subsets function can be denoted as subsets(S,T)={T Tₐₜₜᵣ} where Tₐₜₜᵣ is the set of the most influential transcript units on S.

The result of he subsets function is a set of modified documents T′.

The second function is a contrast function contrast(sᵢ,T,C)→D. This measures the difference in response D of the summary model to the modified documents T′∈C. This can be a difference in probability of Sᵢ, relative increase in probability or any other similar function that represents a change in output of the model from changing the input from the document T to the modified document T′. For instance, as discussed above, a difference in probability can be determined as contrast(Sᵢ,T,T′)=P(Sᵢ|T)−P(Sᵢ|T′).

In one implementation, the contrast function may be a difference between mean log-probabilities:

$$\frac{1}{k} [ log P ( {S}_{i} = {s}_{1} , … , {s}_{k} \vert T ) - log P ( {S}_{i} = {s}_{1} , … , {s}_{k} \vert {T}^{′} ) ]$$

where k is the size of the summary unit Sᵢ=s₁, . . . , sₖ (e.g. the number of tokens, such as words, within the summary unit), This function includes normalization to account for the size k of each summary unit.

When applied across a number of different modified documents T′, the contrast function results in a set of differences D (otherwise known as contrastive scores).

The third function is a discriminant function discriminant(D)→{0,1}. This takes the outputs of the contrast function for all modified documents T′ and determines whether or not a summary unit Sᵢ is a hallucination. The main output can be a discrete decision score∈{0,1}; however, the function may additionally output a continuous score or some confidence score representing the confidence in the decision.

In cases where there is only one modified document T′ (e.g. in the leave-all-out case), the discriminant function may be a threshold function. That is, the discriminant function may determine whether the difference is greater than a given threshold and, if so, determine that the summary unit is not erroneous.

Where there are multiple modified documents, the discriminant function can determine whether Sᵢ is a hallucination based on whether D has any outliers. If a unit Sᵢ is a hallucination, then all contrastive differences will be similar, so there will be little to no outliers. On the other hand, if Sᵢ is not a hallucination, then the output of the summary model will be greatly affected by the removal of a critical portion of the document that implied this summary unit Sᵢ. Given this, the difference (contrastive score) will change significantly for this removal, and so this particular score will be presented as an outlier. For instance, where the difference is measured based on the probability of a given summary sentence being generated, the probability of this summary sentence will drop when the relevant portion of the document is removed.

There are a number of techniques for outlier detection. First, outliers may be determined based on a measure of variability or dispersion. One example of this is standard deviation across the differences. The discriminant function can then simply determine a summary unit Sᵢ to not be a hallucination if the standard deviation exceeds a threshold. Alternatively, the discriminant function can determine a number of outliers. For instance, an outlier may be any contrastive score that lies more than a given threshold distance from the mean. Alternatively, a machine learning model (e.g. a support vector machine or random forest) may be used to detect outliers. In any case, if the set of differences D for a summary unit sᵢ has any outliers then the summary unit sᵢ is determined to not be a hallucination. Equally, if there are no outliers, then the summary unit St is determined to be a hallucination.

Given the above three functions, the method can determine if a given unit Sᵢ (e.g. sentence) of a summary S is a hallucination by determining a set of modified documents T′ using the subsets function, determining a set of differences using the contrast function, and determining whether the unit Sᵢ is a hallucination based on the differences (e.g. based on the variation or discrepancy across the differences or the number of outliers in the differences) using the discriminant function.

Whilst the methodology described herein can be applied to a summary of any type of document, this can be particularly useful the summarisation of transcripts and in particular, transcripts of medical consultations, as accuracy is particularly important in this context. Furthermore, the likelihood of erroneous sentences can increase in situations where the summary is being generated based on a reduced amount of information (e.g. based on a stream of information received in real-time, rather than a complete document received in one package).

### Transcription System

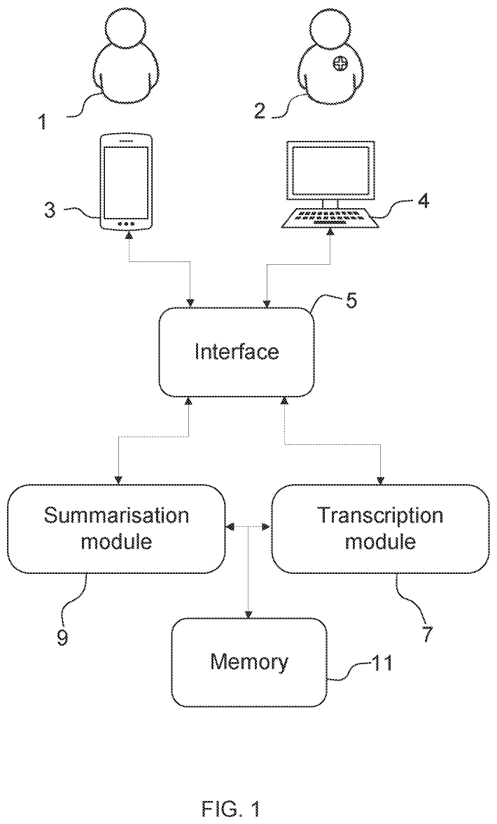

FIG. 1 shows a block diagram of a communication system including automatic transcription summarisation. A first user 1 (e.g. a patient) communicates to the communication system via a mobile phone 3. However, any device could be used which is capable of communicating information over a computer network, for example, a laptop, tablet computer, information point, fixed computer, voice assistant, etc.

The mobile phone 3 is configured to communicate with an interface 5 of the communication system (e.g. via a network connection). The interface 5 facilitates communication with a second user 2 (in this case, a doctor) via a computer 4. However, any device could be used which is capable of communicating information over a computer network, for example, a laptop, tablet computer, information point, fixed computer, voice assistant, etc.

The communication system is configured to establish a communication channel between the mobile phone 3 and the computer 4. This communication channel may convey audio and/or video information between the mobile phone 3 and the computer 3. For instance, a video feed of the first user 1 may be sent to the computer 4 via the interface 5 and a video feed of the second user 2 may be sent to the mobile phone 3 via the interface 5. The communication channel may be managed by the interface 5. The communication channel may convey speech information (e.g. an audio feed of speech) between the users 1, 2 to facilitate a remote conversation.

The communication system may transcribe any speech within the conversation (taken from the communication channel) and provide a summary of the conversation. Accordingly, the interface 5 may pass audio information to a transcription module 7 configured to generate a transcription of the speech. A transcription may be a set of words representing the words spoken in the audio information. The transcription module may utilise any known audio to text transcription method.

The transcription module 7 is configured to send a copy of the transcription to a summarisation module 9 for the generation of a summary of the transcription.

The summarisation module 9 is configured to generate a summary of the transcription, e.g. a set of words that represents the most important information within the transcription in a shorter or more compressed form. The summarisation module 9 may be configured to generate a summary of the conversation between the first user 1 and second user 2 in real time without having to wait for a full transcription of the conversation (i.e. without having to wait until the end of the conversation). Alternatively, the summarisation module 9 may be configured to generate a summary once a full transcription has been received.

The summarisation module 9 (or another module, separate to the summarisation module 9) is configured to remove erroneous sentences from the summary using the methodology described herein. This generates a corrected summary.

The summarisation module 9 may be configured to send the corrected summary to one or both of the first user 1 and the second user 2 (e.g. the doctor) via the interface 5. Similarly, the transcription module 7 may be configured to send the transcription, as it is generated and updated, to one or both of the first user 1 and the second user 2 (e.g. the doctor) via the interface 5. The summary and/or transcription may be displayed to the respective user, and the user may make alterations or corrections as the transcription and/or summary is generated. In addition, the summary and/or transcription may be stored in memory 11 for access by one or both of the users 1, 2 after the conversation has ended.

As discussed above, summarisation systems can sometimes generate erroneous text (“hallucinations”). The present methodology allows the identification of erroneous text to filter out erroneous text and/or highlight potentially erroneous text to an end user for consideration. Whilst this methodology is described herein with regard to transcriptions of speech, it can be applied to any form of text. Furthermore, whilst the document and/or summary may be divided into different sentences for analysis, alternative units (groups or subsets of one or more words) may be utilised.

The methods described herein may be implemented generally using computing systems that include neural networks. A neural network (or artificial neural network) is a machine learning model that employs layers of connected units, or nodes, which are used to calculate a predicted output based on an input. Multiple layers may be utilised, with intervening layers relating to hidden units describing hidden parameters. The output of each layer is passed on to the next layer in the network until the final layer calculates the final output of the network. The performance of each layer is characterised by a set of parameters that describe the calculations performed by each layer. These dictate the activation of each node. The output of each node is a non-linear function of the sum of its inputs. Each layer generates a corresponding output based on the input to the layer and the parameters for the layer.

### Automatic Text Summarisation

Automatic summarisation is the task of summarising an input document into a shorter summary with the use of a computer system. The summary need not include words selected from the initial input, but instead can be a paraphrasing of the important information within the input document, potentially using vocabulary absent from the input document.

A summarisation system can include a sequence to sequence deep learning model made up of two main components: an encoder, which takes in the input document as a sequence of tokens; and the decoder, which produces the output summary one token at a time.

As discussed herein, the summarisation system deals with “tokens”. Each token may be a unit of text, such as a word. Each word may be any string of characters. Generally, this is a word from a dictionary, but this need not be the case. For instance, a start of sequence token <SOS> (otherwise known as a start of sentence token) may be used to indicate the start of a string of generated text (e.g. the start of a summary), and an end of sequence token <EOS> (otherwise known as an end of sentence token) may be used to indicate the end of a string of generated text (e.g. the end of a summary).

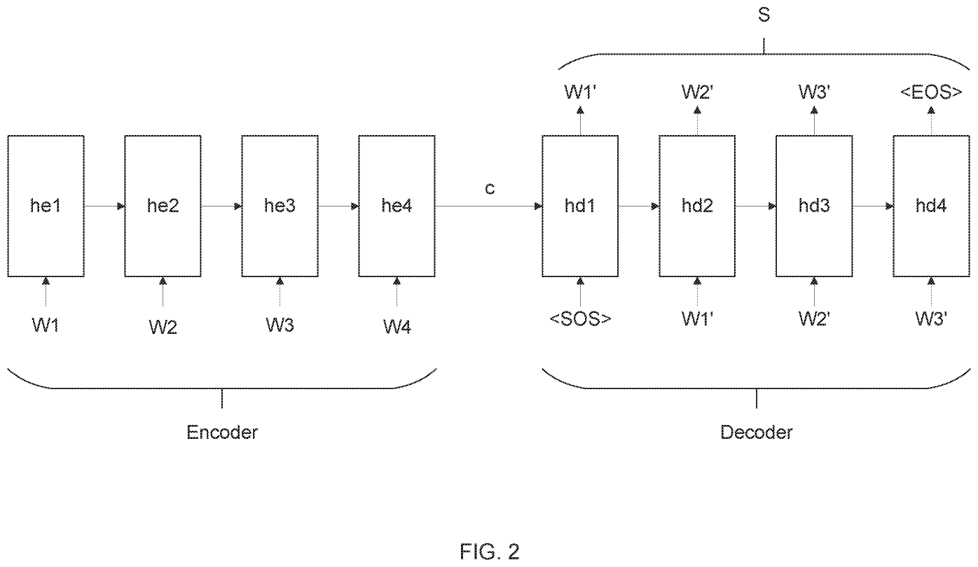

FIG. 2 shows an encoder-decoder structure for summarisation.

The encoder receives a sequence of words, in this case, words W1, W2, W3 and W4. The encoder generates a context vector c comprising one or more encoder hidden states based on the input words and passes the context vector c to a decoder. The decoder receives a start of sequence token <SOS> and generates a sequence of summary words S based on (conditioned on) the context vector c.

Both the encoder and decoder are recurrent neural networks (RNNs). The encoder generates encoded words he1-he4 over a number of time steps (in this case, four time steps). At each time step, the encoding is conditioned on the encoded word from the previous time step. FIG. 2 shows flow of data over time, with time increasing from left to right.

The first word W1 is input into the encoder to produce a respective encoded word he1 (a first encoder hidden state). This encoded word he1 is fed back into the encoder for the next time step. At the next time step, the encoder receives the next input word W2 and the previous encoded word he1 and generates the next encoded word het (a second encoder hidden state). In this way, an encoded word (encoder hidden state) is generated for each word in the input sentence, with each encoded word being dependent on the preceding encoded word. After the last word W4 is encoded, the final encoding (the final encoder hidden state) is then passed as a context vector c to the decoder. The context vector represents an encoding of the information within the input sentence.

The decoder receives the context vector and is configured to determine a summary S comprising a set of words (usually of reduced length relative to the input sentence) that summarises the information conveyed in the context vector. A similar recurrent architecture is used; however, in this case, the decoder receives the context vector and a start of sequence token <SOS>. The output of the decoder at the first time step is a probability vector detailing the respective probabilities of each word in the vocabulary representing an accurate first word in a summary of the input text. Based on this vector of probabilities, a first decoded word W1′ may be selected (by selecting the word having the highest probability).

The hidden state hd1 is fed back into the decoder for the next time step. The first decoded word W1′ is also fed back into the decoder, as the input for the next time step. In this way, the decoded word output at each time step is passed to the next time step as an input. In addition or alternatively to the decoded word W1′, the probability vector from the previous step may be fed into the decoder. This continues until the decoder generates an end of sequence token <EOS>. In the present case, three decoded words are generated by the decoder (W1′, W2′ and W3′) which form the summary S of the input sentence (W1, W2, W3 and W4).

The encoder therefore encodes the input sequence of tokens (words) as a context vector. The decoder takes the context vector and generates a target sequence of tokens (decoded words) as a summary. Generally, the summary is a compressed version of the input sequence. Summarisation differs from other natural language transformation methods, such as machine translation, in that the output is a summary that is generally shorter (potentially much shorter) than the input, and which is compressed in a lossy manner, such that key concepts are maintained but extraneous detail is lost. This differs from machine translation in that machine translation tends to aim to be lossless. Furthermore, unlike most machine translation, the summary is usually in the same language as the input sequence.

FIG. 2 shows the encoder encoding each word in sequence. In addition to each word being input to the encoder, additional linguistic features relating to the input word/token may be input with each word, such as parts of speech tags, named-entity tags, and term frequency (TF) or inverse document frequency (IDF) statistics.

Whilst FIG. 2 shows the context vector being passed to the decoder only at the first time step of decoding, the encoder decoder structure can be adapted to include attention at each decoding step over each embedded word (each embedding step). In this case, each embedded word is passed to the decoder which applies attention over the embedded words at each step when generating decoded words.

It should be noted that the methodology of FIG. 2 is but one example of a summarisation model. Any summarisation model may be utilised in the embodiments described herein, provided the summarisation model is able to calculate the probability of a particular set of words representing an accurate summary of the input text.

As discussed herein, summary models can sometimes generate erroneous text that does not in fact summarise the input text, Accordingly, post processing may be helpful to remove this erroneous text.

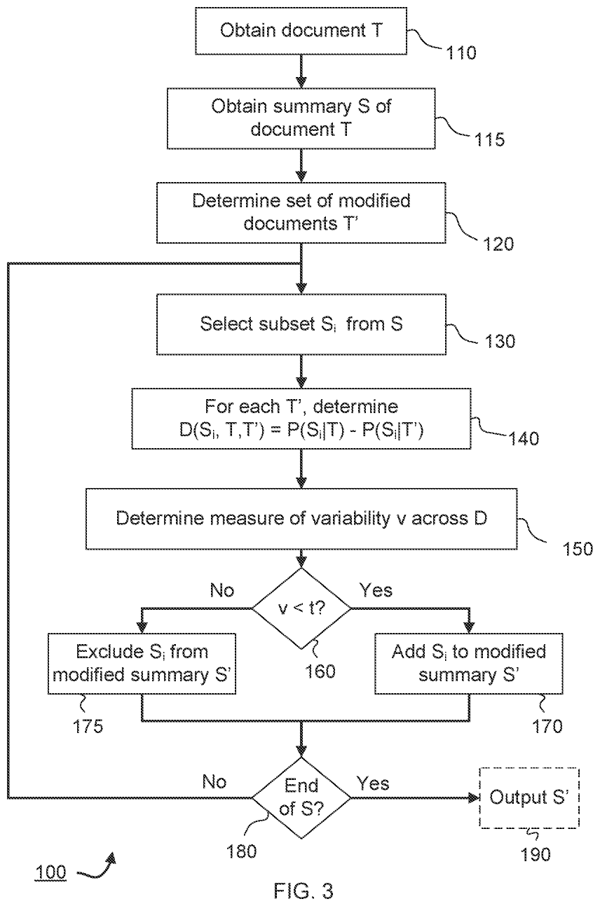

FIG. 3 shows a method 100 for removing erroneous statements from a computer-generated summary of text according to an embodiment. The method begins by obtaining a document T comprising a set of words 110. A summary S of the document T is then obtained 115. The summary S may be obtained at this point by inputting the text of the document T into a summary neural network. Alternatively, the summary S may be received or retrieved at this stage having been pre-generated at an earlier stage and/or generated by an external system.

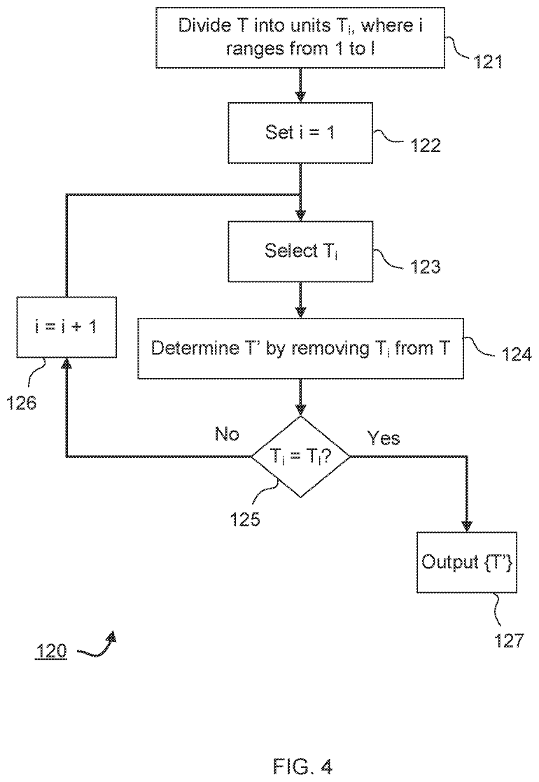

A set of modified documents T′ is then obtained 120. As discussed above, each modified document T′ includes a different subset of words selected from the input document T. For instance, each modified document T′ may comprise all words from the input document with the exclusion of a corresponding excluded subset of one or more words (e.g. a particular one or more words or one or more sentences excluded from the modified document T′). The modified documents T′ may be generated such that each word and/or subset of words is excluded at least once across all modified documents T′. The method of generating the modified documents is described in more detail with reference to FIG. 4.

A subset of one or more words Sᵢ is then selected from the summary S130. As discussed above, this subset may be a unit comprising a predefined number of one or more words, a predefined number of one or more sentences, a predefined number of one or more statements, or a predefined number of one or more phrases. The method may start with the first subset S₁ and work in sequence through the summary S until the final subset Sₙ has been considered (where n is the number of subsets Sᵢ in the summary S).

Then, for each modified document T′, a difference is determined between a probability that the subset Sᵢ summarises the document T and a probability that the subset Sᵢ summarises the modified document T′ 140. In particular, this may be determined by determining

D(Sᵢ,T,Tᵢ)=P(Sᵢ|T)−P(Sᵢ|T′)

where P(Sᵢ|T) is the probability that the subset Sᵢ summarises the document T (the probability of the neural network generating Sᵢ when given T) and P(Sᵢ|T′) is the probability that the subset Sᵢ summarises the modified document T′ (the probability of the neural network generating Sᵢ when given T′). These probabilities can be determined be inputting T and T′ respectively into the summarisation neural network and selecting from the output probabilities the probabilities of the specific words sᵢ within Sᵢ. These probabilities can then be combined (e.g. through multiplication) in order to obtain the probability of the summary unit Sᵢ: P(Sᵢ)=Πᵢ₌₁^{k}P(sᵢ|sᵢ₋₁, sᵢ₋₂, . . . , s₁).

Once each difference D has been calculated, a measure of variability (or dispersion) v across these differences D is determined 150. This measure of variability v may be the standard deviation over these differences D or a measure of a number of outliers. The higher the variability v, the higher the change in input affects the output of the summarisation neural network. Accordingly, where there is a high variability v, the subset of words sᵢ is strongly affected by changes to the input and therefore is more likely to be an accurate summary of the document T, rather than a hallucination that does not accurately summarise the document T.

The method then determines whether the measure of variability v is greater than a threshold variability 160. This threshold may be adjusted based on how much information the user wishes to filter out. If the variability v exceeds the threshold (e.g. if number of outliers is greater than or equal to 1), then the subset Sᵢ is determined to be an accurate section of the summary, and is therefore included within a corrected summary S′ to be output 170. If the variability v does not exceed the threshold (i.e. is less than or equal to the threshold), then the subset Sᵢ is determined to be an erroneous or inaccurate section of the summary (e.g. a hallucination), and is therefore excluded from the corrected summary S′ 175.

It is then determined whether all subsets Sᵢ of the summary S have been considered 180 (i.e. have been determined to be either inaccurate or accurate). If not, then the method returns to step 130 to select another subset Sᵢ for consideration. If all subsets Sᵢ of the summary S have been considered, then the corrected summary S′ can be output 190. In addition, or alternatively, each accurate subset Sᵢ may be output at the point that it is determined to be accurate (i.e. instead of waiting Ling all subsets Sᵢ have been considered).

Notably, the method of FIG. 3 determines a measure of variability across multiple differences determined from multiple modified documents. In an alternative arrangement, only one modified document is determined (e.g. an empty modified document is determined). In this case, step 150 may be replaced with a set of determining whether the difference in probability for the single modified document is greater than a threshold. If so, then the summary unit Sᵢ is determined to be not-erroneous. If not, then the summary unit Sᵢ is determined to be erroneous.

FIG. 4 shows a method 120 of determining a set of modified documents T′ according to an embodiment. The original document T is divided into l units Tᵢ (where i ranges from 1 to l) 121. Each unit may comprise a predefined number of one or more words, a predefined number of one or more sentences, a predefined number of one or more statements, or a predefined number of one or more phrases.

The method may start with the first unit Tᵢ and work in sequence through the document T until the final unit Tᵢ has been considered. Accordingly, the method may initialise 122 at i=1. The unit Tᵢ is selected 123 and a modified document T′ᵢ is determined by removing Tᵢ from T (i.e. by selecting all words from T other than those in Tᵢ) 124.

It is then determine whether the end of T has been reached 125 (i.e. whether the currently selected Tᵢ is the last unit Tᵢ). If not, then i is incremented by 1 and the method returns to step 123 to select the next unit and determine the next modified document T′ᵢ. If the end of the document T has been reached, then the modified documents T′ are output 127. In the context of the method of FIG. 3, this output involves utilising the modified documents T′ to identify erroneous section(s) of the summary S.

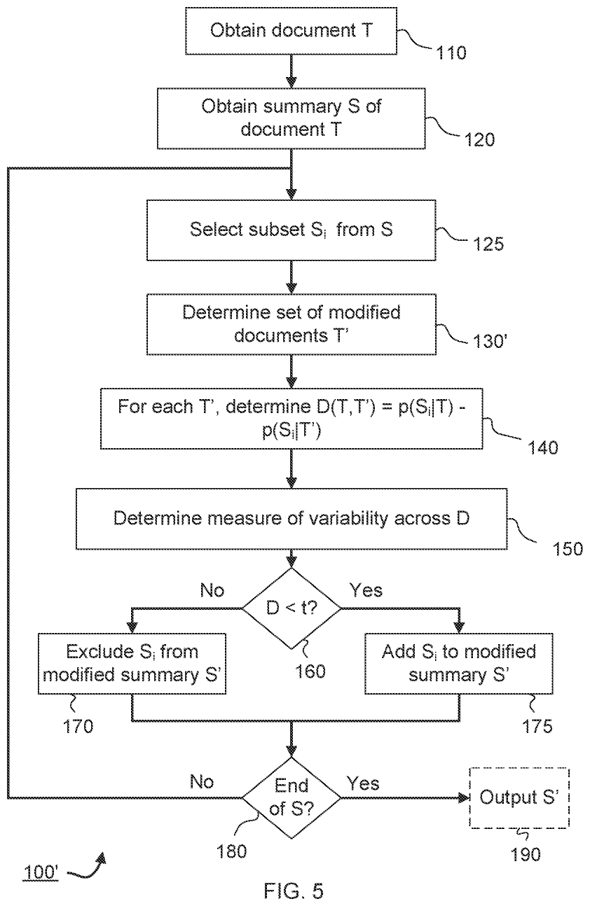

FIG. 5 shows a further method 100′ for removing erroneous statements from a computer-generated summary of text according to a further embodiment. This method is similar to that of FIG. 3, and like steps are repeated with corresponding reference numerals. For simplicity, these steps will not be described again. Having said this, the method of FIG. differs from that in FIG. 3, in that a new set of modified documents T′ is determined for each subset Sᵢ 130′. This allows the most relevant modified documents to be generated each time,

As discussed above, the generation of the set of modified documents may be conditioned on the particular subset Sᵢ being considered. For instance, the units Tᵢ may be sorted in terms of their relevance to Sᵢ. This may be achieved by determining the gradient of the loss of the decoder neural network for a given summary Sᵢ with respect to the hidden states (activations) of a neural network corresponding to the units Tⱼ in the transcript, with appropriate pooling (avg, max, norm, etc.) where there is more than one activation per each such unit. A predefined number of the most relevant units Tᵢ (the units having the highest gradient) may be selected to form the basis of the set of modified documents T′. A corresponding modified document T′ may then be generated for each selected unit Tᵢ by removing this unit Tᵢ from the document T.

Following the generation of the modified documents T′, the method continues as per the method of FIG. 5, however, a new set of modified documents T′ is generated each time a new summary subset Sᵢ is selected.

Implementing this method provides a reduction in the number of modified documents T′ that need to be considered, and therefore a reduction in the number of differences D(Sᵢ,T,Tᵢ) that need to be generated. This methodology can therefore reduce the number of computational steps required. Having said this, performance can be maintained as the selected modified documents T′ would inherently have the greatest effect on the performance of the neural network, so the variability will still be representative of the likelihood that the summary subset Sᵢ is a hallucination.

The methods described herein allow erroneous (e.g. hallucinated) sections of a summary to be removed to improve the accuracy of the summary. This is achieved using just the output from the summary neural network and therefore does not require the training of a bespoke classifier for this task.

Whilst some of the above embodiments have been described with reference to producing summaries of transcriptions of speech, the methodology is generally applicable to any type of summary of any type of document. The term “document” herein means a set of text (i.e. a set of words). Accordingly, the term “document” is generally applicable to any type of text, regardless of content.

Whilst some of the embodiments discussed herein relate to selections, units, sentences or subsets of one or more words, it will be appreciated that the various documents and summaries may be subdivided through various means. Generally, each unit, selection or subset relates to a contiguous selection of one or more words from the respective source text (e.g. document or summary).

### Computing Device

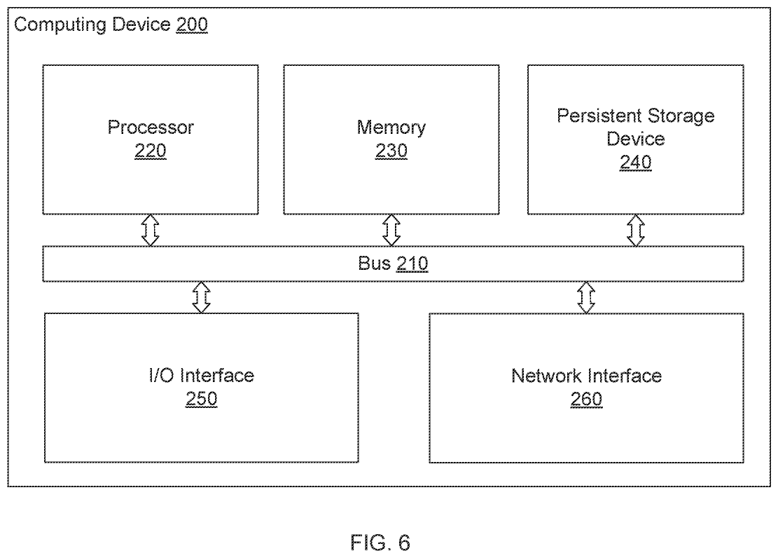

FIG. 6 shows a computing device 200 using which the embodiments described herein may be implemented.

The computing device 200 includes a bus 210, a processor 220, a memory 230, a persistent storage device 240, an Input/Output (I/O) interface 220, and a network interface 260.

The bus 210 interconnects the components of the computing device 200. The bus may be any circuitry suitable for interconnecting the components of the computing device 200. For example, where the computing device 200 is a desktop or laptop computer, the bus 210 may be an internal bus located on a computer motherboard of the computing device. As another example, where the computing device 200 is a smartphone or tablet, the bus 210 may be a global bus of a system on a chip (SoC).

The processor 220 is a processing device configured to perform computer-executable instructions loaded from the memory 230. Prior to and/or during the performance of computer-executable instructions, the processor may load computer-executable instructions over the bus from the memory 230 into one or more caches and/or one or more registers of the processor. The processor 220 may be a central processing unit with a suitable computer architecture, e.g. an x86-64 or ARM architecture. The processor 220 may include or alternatively be specialized hardware adapted for application-specific operations.

The memory 230 is configured to store instructions and data for utilization by the processor 220. The memory 230 may be a non-transitory volatile memory device, such as a random access memory (RAM) device. In response to one or more operations by the processor, instructions and/or data may be loaded into the memory 230 from the persistent storage device 240 over the bus, in preparation for one or more operations by the processor utilising these instructions and/or data.

The persistent storage device 240 is a non-transitory non-volatile storage device, such as a flash memory, a solid state disk (SSD), or a hard disk drive (HDD). A non-volatile storage device maintains data stored on the storage device after power has been lost. The persistent storage device 240 may have a significantly greater access latency and lower bandwidth than the memory 230, e.g. it may take significantly longer to read and write data to/from the persistent storage device 240 than to/from the memory 230. However, the persistent storage 240 may have a significantly greater storage capacity than the memory 230.

The I/O interface 250 facilitates connections between the computing device and external peripherals. The I/O interface 250 may receive signals from a given external peripheral, e.g. a keyboard or mouse, convert them into a format intelligible by the processor 220 and relay them onto the bus for processing by the processor 220. The I/O interface 250 may also receive signals from the processor 220 and/or data from the memory 230, convert them into a format intelligible by a given external peripheral, e.g. a printer or display, and relay them to the given external peripheral.

The network interface 260 facilitates connections between the computing device and one or more other computing devices over a network. For example, the network interface 260 may be an Ethernet network interface, a Wi-Fi network interface, or a cellular network interface.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method for removing erroneous statements from computer-generated summaries of text, the method comprising:
obtaining a document comprising a set of words;
obtaining a summary of the document generated using a summary generation neural network configured to determine a probability of a given set of one or more words summarising an input document;
dividing the summary into sub-summaries, each sub-summary including a corresponding subset of one or more words from the summary; and
for each sub-summary:
determining a set of one or more modified documents, wherein each modified document is determined by removing a corresponding selection of words from the document;
for each modified document, determining, using the summary generation neural network, a difference between a probability that the sub-summary summarises the document and a probability that sub-summary summarises the modified document;
determining whether the sub-summary is erroneous based on the one or more differences; and
in response to determining that the sub-summary is not erroneous, adding the sub-summary to a corrected summary for output.

2. The method of claim 1 wherein determining one or more modified documents comprises determining a plurality of modified documents, each comprising a different selection of words selected from the document.

3. The method of claim 2 wherein determining whether the sub-summary is erroneous based on the one or more differences comprises:
determining a measure of variability across the differences for the modified documents; and
in response to the measure of variability for the sub-summary being greater than a predefined threshold, determining that the sub-summary is not erroneous and adding the sub-summary to the corrected summary for output.

4. The method of claim 3 wherein determining the measure of variability across the differences comprises:
determining a standard deviation over the differences; or
determining a number of outliers within the differences.

5. The method of claim 3 further comprising:
in response to the measure of variability for the sub-summary not being greater than the predefined threshold, determining that the sub-summary is erroneous.

6. The method of claim 2 wherein each modified document comprises every word from the document with the exclusion of a corresponding excluded set of one or more words, wherein the excluded set of one or more words differs for each modified document.

7. The method of claim 6 wherein each excluded set comprises a different:
selection of a predetermined number of words from the document;
selection of a predetermined number of sentences from the document;
selection of a predetermined number of statements from the document; or
selection of a predetermined number of phrases from the document.

8. The method of claim I wherein:
a different set of one or more modified documents is determined for each sub-summary and utilised to determine the one or more differences for the corresponding sub-summary; and
determining the corresponding set of one or more modified documents for a given sub-summary comprises:
determining an influence score for each subset of words in the document, the influence score representing the influence of the subset of words in the document on the probability of the sub-summary according to the summary generation neural network;
determining a selection of subsets of words from the document that have the greatest influence on the sub-summary based on the influence scores; and
determining the set of one or more modified documents for the sub-summary, wherein each modified document is formed through the removal of at least one of the selection of subsets of words from the document.

9. The method of claim 1 wherein the same set of one or more modified documents is used for each sub-summary.

10. The method of claim 1 wherein each of the differences is normalized to account for a size of the respective sub-summary.

11. The method of claim 1 wherein:
determining one or more modified documents comprises determining only one modified document; and
the sub-summary is determined not to be erroneous in response to the difference being greater than a predefined threshold,

12. The method of claim 11 wherein determining only one modified document comprises removing all words from the document.

13. The method of claim 1 wherein determining, using the summary generation neural network, the difference between the probability that the sub-summary summarises the document and the probability that the sub-summary summarises the modified document comprises:
inputting the document into the summary generation neural network to determine a first value representing the probability that the sub-summary summarises the document;
inputting the modified document into the summary generation neural network to determine a second value representing the probability that the sub-summary summarises the modified document; and
determining a difference between the first and second values.

14. The method of claim 1 wherein each sub-summary comprises a different:
selection of a predetermined number of words from the summary;
selection of a predetermined number of sentences from the summary;
selection of a predetermined number of statements from the summary; or
selection of a predetermined number of phrases from the summary.

15. The method of claim 1 further comprising outputting the corrected summary.

16. A system for determining summaries of text over multiple batches of text, the system comprising one or more processors configured to:
obtain a document comprising a set of words;
obtain a summary of the document generated using a summary generation neural network configured to determine a probability of a given set of one or more words summarising an input document;
divide the summary into sub-summaries, each sub-summary including a corresponding subset of one or more words from the summary; and
for each sub-summary:
determine a set of one or more modified documents, wherein each modified document is determined by removing a corresponding selection of words from the document;
for each modified document, determine, using the summary generation neural network, a difference between a probability that the sub-summary summarises the document and a probability that sub-summary summarises the modified document;
determine whether the sub-summary is erroneous based on the one or more differences; and
in response to determining that the sub-summary is not erroneous, add the sub-summary to a corrected summary for output.

17. A non-transitory computer readable medium comprising computer executable instructions that, when executed by one or more processors, cause the one or more processors to perform a method comprising:
obtaining a document comprising a set of words;
obtaining a summary of the document generated using a summary generation neural network configured to determine a probability of a given set of one or more words summarising an input document;
dividing the summary into sub-summaries, each sub-summary including a corresponding subset of one or more words from the summary; and
for each sub-summary:
determining a set of one or more modified documents, wherein each modified document is determined by removing a corresponding selection of words from the document;
for each modified document, determining, using the summary generation neural network, a difference between a probability that the sub-summary summarises the document and a probability that sub-summary summarises the modified document;
determining whether the sub-summary is erroneous based on the one or more differences; and
in response to determining that the sub-summary is not erroneous, adding the sub-summary to a corrected summary for output.
